(19) United States
(12) Patent Application Publication
(10) Pub. No.: US 2022/0206683 A1
(43) Pub. Date: Jun. 30, 2022

(54) QUICK MENU SELECTION DEVICE AND METHOD

(71) Applicant: Microsoft Technology Licensing, LLC, Redmond, WA (US)

(72) Inventors: Masaaki FUKUMOTO, Shenzhen City (CN); Paul KOS, Shenzhen (CN); Nicolas SCHMITT, Redmond, WA (US); Go OSAKI, Redmond, WA (US); Kelong ZHAO, Redmond, WA (US); Chun Lai ZHANG, Redmond, WA (US); Chunde LIU, Redmond, WA (US); Hao ZHUANG, Redmond, WA (US); Shuling CHEN, Redmond, WA (US); Yu YU, Redmond, WA (US); Qing FENG, Redmond, WA (US)

(21) Appl. No.: 17/606,993

(22) PCT Filed: May 19, 2019
(86) PCT No.: PCT/CN2019/086190

§ 371 Date: Oct. 27, 2021

(51) Int. Cl. G06F 3/04886; G06F 3/02; G06F 3/0482; G06F 3/0489

(52) U.S. Cl. CPC G06F 3/04886; G06F 3/0213; G06F 2203/04804; G06F 3/0489; G06F 3/0482

(57) ABSTRACT

Implementations of the subject matter described herein provide a keyboard and an electronic device. The keyboard comprises a touch-sensitive region configured to send an indication of a position of a touch to the electronic device. The electronic device may display a menu including a plurality of configurable menu items. A shape of the menu matches a shape of the touch-sensitive region, and the menu item corresponding to the touch position may be highlighted, such that the user may acknowledge the touch position without looking at the keyboard. In this case, input efficiency may be improved in case of selecting menu items, since the user does not need to divert its sight from the display to the keyboard or the pointing device.

### BACKGROUND

Applications or software with various functions have been widely developed to facilitate business and entertainment. In some circumstances, a menu of an application or software needs to be selected to achieve a certain function. Menu selection by a pointing device is commonly used. However, it requires a relatively long travel of a pointer and large eye movements. Alternatively, a conventional keyboard may be used to achieve menu selection. In this circumstance, the user needs to memorize various combinations of shortcut keys.

### SUMMARY

Implementations of the subject matter described herein provide a keyboard and an electronic device. The keyboard comprises a touch-sensitive region. The touch-sensitive region is configured to determine the position of a touch in response to detecting the touch on or above the touch-sensitive region. The touch-sensitive region is further configured to send an indication of the position of the touch to an electronic device to cause the electronic device to select a menu item of a menu on a display of the electronic device based on the position of the touch. A shape of the menu matches a shape of the touch-sensitive region.

It is to be understood that the Summary is not intended to identify key or essential features of implementations of the subject matter described herein, nor is it intended to be used to limit the scope of the subject matter described herein. Other features of the subject matter described herein will become easily comprehensible through the description below.

### BRIEF DESCRIPTION OF THE DRAWINGS

The above and other objectives, features and advantages of the subject matter described herein will become more apparent through more detailed depiction of example implementations of the subject matter described herein in conjunction with the accompanying drawings, wherein in the example implementations of the subject matter described herein, same reference numerals usually represent same components.

FIG. 1 illustrates an environment of a computer including a conventional keyboard;

FIG. 2 illustrates a keyboard according to an embodiment of the subject matter described herein;

FIG. 3 illustrates a view of an application or software including a menu according to an embodiment of the subject matter described herein;

FIG. 4 illustrates the menu of FIG. 3 with a translucent indicator of a finger according to an embodiment of the subject matter described herein;

FIG. 5 illustrates the touch of fingers on the touch-sensitive region according to an embodiment of the subject matter described herein;

FIG. 6 illustrates a transition from a menu to a submenu for handwriting according to an embodiment of the subject matter described herein;

FIG. 7 illustrates a transition from a menu to a submenu for zooming according to an embodiment of the subject matter described herein;

FIG. 8 illustrates another transition from a menu to a submenu for zooming according to an embodiment of the subject matter described herein;

FIG. 9 illustrates a transition from a menu to a submenu for scrolling according to an embodiment of the subject matter described herein;

FIG. 10 illustrates another transition from a menu to a submenu for scrolling according to an embodiment of the subject matter described herein;

FIG. 11 illustrates a keyboard with proximity sensors according to an embodiment of the subject matter described herein;

FIG. 12 illustrates a keyboard with turntables according to an embodiment of the subject matter described herein;

FIG. 13 illustrates another keyboard according to an embodiment of the subject matter described herein;

FIG. 14 illustrates the touch-sensitive region of keyboard of FIG. 13 according to an embodiment of the subject matter described herein;

FIG. 15 illustrates software including another menu according to an embodiment of the subject matter described herein;

FIG. 16 illustrates an electronic device according to an embodiment of the subject matter described herein;

FIG. 17 illustrates the electronic device of FIG. 16 displaying a keyboard according to an embodiment of the subject matter described herein;

FIG. 18 illustrates the electronic device of FIG. 16 displaying a keyboard according to another embodiment of the subject matter described herein;

FIG. 19 illustrates a keyboard for a laptop according to an embodiment of the subject matter described herein;

FIG. 20 illustrates a keyboard with a palm-rest component according to an embodiment of the subject matter described herein; and

FIG. 21 illustrates a computer-implemented method for selecting a menu with a keyboard according to another embodiment of the subject matter described herein.

### DETAILED DESCRIPTION

The subject matter described herein will now be discussed with reference to several example implementations. It should be understood these implementations are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below. A definition of a term is consistent throughout the description unless the context clearly indicates otherwise.

Some values or value ranges might be described in the following. It is to be understood that these values and value ranges are only for the purpose of illustration, which may be advantageous to practice the idea of the subject matter described herein. However, depiction of these examples is not intended to limit the scope of the subject matter described herein in any manner. According to the specific application scenarios and needs, the values or value ranges may be set otherwise.

Menu selection is generally inevitable for using applications or software. As mentioned above, conventional menu selection may require either a combination of a relatively long travel of a pointer and large eye movements, or massive effort for memorizing various combinations of shortcut keys.

Embodiments of the subject matter described herein provide a keyboard with quick menu selection. By displaying a menu including customized menu items and matching a touch-sensitive region of the keyboard, a user may quickly select a target menu item based on a position of a touch on or above the touch-sensitive region without looking at the keyboard. As such, operation time for menu selection is greatly reduced, and the user does not have to memorize various combinations of shortcut keys.

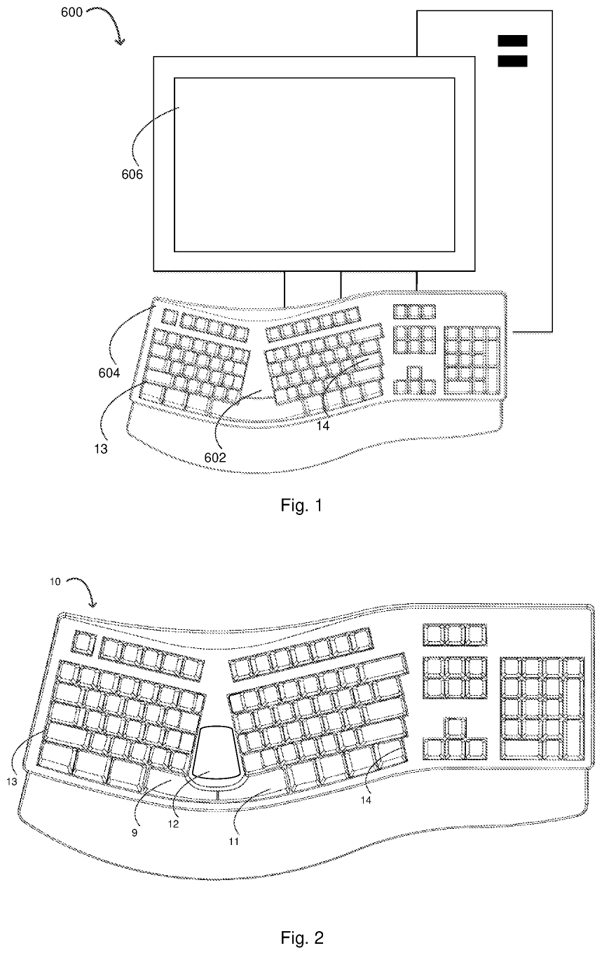

FIG. 1 illustrates a computer 600 including a convention keyboard 604. The convention keyboard 604 is an ergonomic keyboard including a left key region 13, a right key region 14, a functional key region and a keypad. A blank area 602 exists between the left key region 13 and the right key region 14 in some keyboards. In some other keyboards, the blank area 602 may be used to providing a scrolling wheel. However, the scrolling wheel only performs a simple function of scrolling pages. This is insufficient for various menu selections.

FIG. 2 illustrates a keyboard 10 according to an embodiment of the subject matter described herein. The keyboard 10 is an ergonomic keyboard including a left key region 13, a right key region 14, a functional key region and a keypad. The keyboard 10 also includes a touch-sensitive region 12 between the left and right key regions 13 and 14. By setting the touch-sensitive region 12 between the left and right key regions 13 and 14, the user may conveniently and quickly operate the touch-sensitive region 12 with a finger, such as an index finger, without looking at the touch-sensitive region 12 and moving an entire hand.

The touch-sensitive region 12 is configured to detect a touch on or above the touch-sensitive region 12. The touch-sensitive region 12 may be a touch pad, a magnetic induction sensor or other touch-sensitive devices. The touch pad may detect a touch of a finger, a stylus or other objects on the touch pad. In another example, the touch pad may detect a plurality of touches of fingers or objects on the touch pad such that some functions may be performed with multiple touches.

The touch pad may detect touch shape (profile of the touch of the finger) on the touch pad, such that the touch pad may determine which hand is used. For example, the touch pad may determine an ellipse shape of a finger, and the processor of the electronic device may determine which hand is used based on the long axis orientation of the ellipse shape. In addition, the processor may determine the tilt degree of the translucent indicator of the finger, as described below with reference to FIG. 4.

In another example, the touch pad may determine a press or double click from an object, such as the finger, based on variation of touch area of the object. Alternative, the touch pad may include conventional mechanism under the surface of the touch pad to sense the press and the double click.

The magnetic induction sensor may sensor a finger, a stylus or other objects hanging over the magnetic induction sensor and relevant movement. The magnetic induction sensor may include conventional mechanism under the surface of the magnetic induction sensor to sense the press and the double click.

Although the touch pad and the magnetic induction sensor are illustrated for the touch-sensitive region 12, this is only for illustration without suggesting any limitations as to the scope of the subject matter described here. Other touch-sensitive component may be applied for the touch-sensitive region 12. For example, a capacitive touch screen may be used for the touch-sensitive region 12.

The touch-sensitive region 12 may detect a press or a predetermined gesture, such as a slide, on or above the touch-sensitive region. The touch-sensitive region 12 may send an indication of initialization to the electronic device to cause the electronic device to display a menu in response to detecting the press or the predetermined gesture on or above the touch-sensitive region.

In another example, the touch-sensitive region 12 may detect a predetermined gesture, such as a tap or a swipe with two or more fingers on or above the touch-sensitive region, and the touch-sensitive region 12 may send an indication of initialization to the electronic device in response to detecting the predetermined gesture.

In a further example, the user may simultaneously press the adjacent left and right spaces keys 9 and 11 with a finger, such as a thumb of a left or right hand. The keyboard 10 may then send the indication of initialization to the electronic device to cause the electronic device to display a menu in response to detecting the press on both the left and right spaces keys 9 and 11.

Although the adjacent left and right spaces keys 9 and 11 are illustrated as separate space keys, this is only for illustration without suggesting any limitations as to the scope of the subject matter described here. The left and right spaces keys 9 and 11 may be formed as one space key in some examples. In this case, the space key may be combined with other key, such as “Alt”, to trigger the indication of initialization.

Alternatively, the keyboard 10 may detect a predetermined combination of other keys, such as “Windows+Z”, and send the indication of initialization to the electronic device to cause the electronic device to display a menu in response to detecting the predetermined combination of keys.

The processor of the electronic device may receive the indication of initialization.

In response to receiving the indication of initialization, the electronic device enters a menu selection mode from a typing mode, and the processor causes the display of the electronic device to display the menu.

Although a press or a slide on or above the touch-sensitive region is illustrated to cause the display of the menu, this is only for illustration without suggesting any limitations as to the scope of the subject matter described here. Other initialization approaches may be applied to cause the display of the menu. For example, a predetermined key near the touch-sensitive region 12 may be configured to be pressed to send the indication of initialization to the electronic device.

The touch-sensitive region 12 may determine the position of the touch in response to detecting a touch on or above the touch-sensitive region 12. The touch-sensitive region 12 may have an absolute pointing mode to detect absolute X/Y position of the touched point in real time.

The touch-sensitive region 12 may then send an indication of the position of the touch to a processor of an electronic device to cause the electronic device to select a menu item of a menu on a display of the electronic device based on the position of the touch. The electronic device may include a computer, a laptop, a tablet, and other devices having a display.

The processor of the electronic device may receive the indication of the position of the touch on or above a touch-sensitive region 12 of the keyboard 10. The processor of the electronic device may select a menu item of a menu based on the position of the touch. The menu is presented on a display of an electronic device, and the shape of the menu matches a shape of the touch-sensitive region.

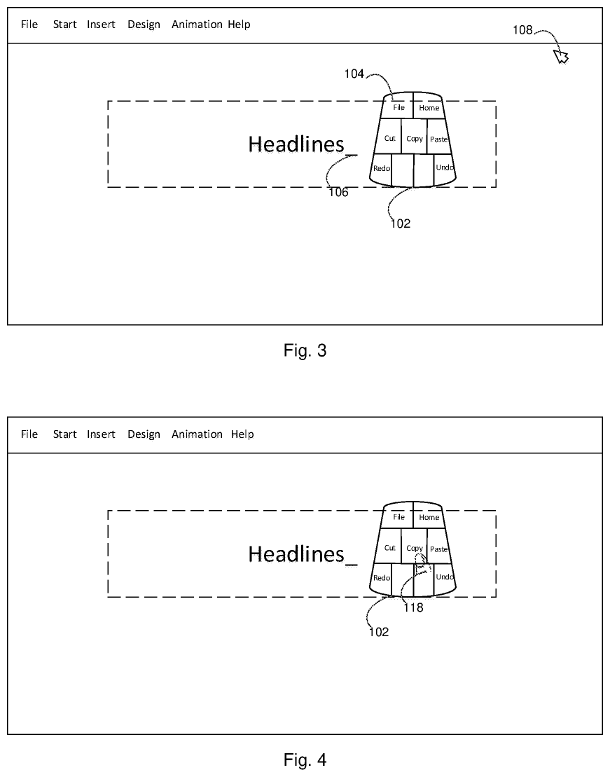

FIG. 3 illustrates a view of an application or software including a menu 102 according to an embodiment of the subject matter described herein. The menu 102 may float over the view of the application or the software. The shape of the menu 102 matches the shape of the touch-sensitive region 12.

In an example, the menu 102 comprises a plurality of configurable menu items matching respective sub-regions of the touch-sensitive region. Each of the menu items may be customized or assigned to various functions, depending on the application or software being used. For example, the menu item 104 may be assigned to the “File” function for a first application or software, but it may be assigned to “Undo” function for a second application or software.

By customization, the user may choose frequently used functions for certain menu items. For example, the user may assign frequently used functions to the peripheral regions of the menu 102, such that the user may easily and more accurately selecting the frequently used functions without looking at the keyboard 10. This is because the user may more easily feel the edge of the touch-sensitive region 12 than other areas.

In an example, the menu is configured to locate at or near an input cursor 106 or a mouse cursor 108. By locating the menu at or near an input cursor 106 or a mouse cursor 108, it may significantly reduce eye movement, such that the user needs not to divert his or her sight, and operation with the keyboard 10 will be faster and more convenient.

In case that a menu item, for example the menu item 104, is selected, the function may be performed by the processor of the electronic device and the menu selection may be completed. In an example, the keyboard 10 detects a press or double-clicks on the touch-sensitive region 12. The keyboard 10 then sends an indication of selection to the processor of the electronic device. Alternatively, a predetermined key or a key combination, such as “Enter”, may be pressed to send the indication of selection.

The processor of the electronic device may receive the indication of selection. The processor may select the menu item in response to receiving the indication of selection. In response to selecting the menu item 104, the processor performs the function corresponding to the menu item. If the menu selection is completed, the processor causes the display of the electronic device not to display the menu.

In another example, the processor does not automatically cause the electronic device not to display the menu. The processor causes the display of the electronic device not to display the menu in response to receiving the indication of completion. For example, the user may press a predetermined key, such as the “ESC” key, to send the indication of completion to the processor. The processor may cause the electronic device not to display the menu in response to receiving the indication of completion.

By using the customized menu matching the touch-sensitive region of the keyboard, the users can significantly improve menu selection efficiency, without memorizing conventional shortcut key combinations or operating another pointer device, such as a mouse, to select menu items.

All the operations may be done at the keyboard with a minimum movement of hand. The user may need not to look at the keyboard 10, because the touch-sensitive region is arranged at a convenient place, such as a place between the left and right key regions of the ergonomic keyboard 10. The user may find the touch-sensitive region depending on “muscle memory” or “spatial memory”, without looking at the keyboard.

By using absolute pointing mode along with the user's “muscle memory” or “spatial memory”, the user can directly reach targeted menu items without lengthily moving mouse pointer from the current pointer position to the targeted menu items by sliding fingers, because the (well-trained) user knows the position of the targeted menu item on the trackpad. If needed, the user can also adjust targeted menu item by sliding fingers after initial pointing.

FIG. 4 illustrates the menu of FIG. 3 with a translucent indicator of a finger 118 according to an embodiment of the subject matter described herein. In order to assist in selection of a menu item, the currently focused menu item may be highlighted. An indicator highlighting the currently focused menu item may be provided on the menu 102.

In an example, a translucent indicator of a finger 118 may be provided on the menu 102 based on the position of the touch. The translucent indicator of a finger 118 may move, as the finger moves on the touch-sensitive region of the keyboard, so as to dynamically highlight the currently focused menu item.

In addition, the tile degree of the translucent indicator of a finger 118 may be adjusted based on the orientation of the touch of the finger. For example, the touch-sensitive region 12 may determine the touch shape (profile of the touch of the finger), and send an indication of the touch shape to the processor of the electronic device. In response to receiving the indication of the touch shape, the processor may cause the display to present the translucent indicator of a finger 118 accordingly.

For example, the translucent indicator of a finger 118 may tilt to a direction substantially same as the finger on or above the touch-sensitive region 12. Moreover, in case that the finger on or above the touch-sensitive region 12 tilts more or less, the translucent indicator of a finger 118 may be presented to tilt more or less accordingly.

In another example, a translucent cross may be may be provided on the menu 102, instead of a translucent finger. In a further example, the currently focused menu item may have a color different from the color of other menu items, such that the user may acknowledge on which item is focused.

Although an indicator or a different color is illustrated to highlight the currently focused menu item, this is only for illustration without suggesting any limitations as to the scope of the subject matter described here. Other approaches may be applied. For example, both the translucent finger and the highlight color may be provided to show the currently focused menu item.

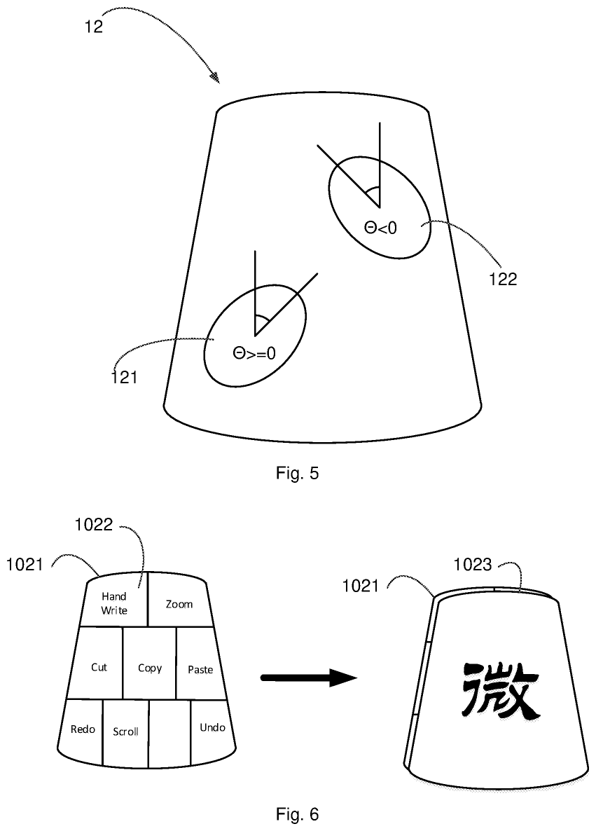

FIG. 5 illustrates an example of touches on the touch-sensitive region 12 according to an embodiment of the subject matter described herein. As described above, the touch-sensitive region 12 may determine an ellipse shape of a finger, and determine which hand is used based on the long axis orientation of the ellipse shape. Specifically, the touch-sensitive region 12 may determine an angle θ between long orientation of an ellipse shape of a touch and a vertical direction based on the touch.

In case that the angle θ is not below than zero, it indicates that the left hand is used. In case that the angle θ is below than zero, it indicates that the right hand is used. In another example, the specific degree of the angle θ may be determined. In response to receiving an indication of the angle θ, the processor of the electronic device may display the translucent indicator of a finger 118 with an orientation corresponding to the angle θ. As such, it can improve user experience, because the user may feel strange, if the displayed finger image's angle different from operated finger.

For example, in case that a first finger touches the touch-sensitive region 12, the touch-sensitive region 12 may determine the ellipse shape 121 of the touch of the first finger. For example, the first finger may be the left index finger. The touch-sensitive region 12 may determine an angle θ between the long orientation of the ellipse shape 121 and the vertical direction. It is determined that the angle θ is not below than zero, and the touch-sensitive region 12 may send an indication of the angle θ and/or the left hand to the processor of the electronic device.

Analogous operation may apply to the ellipse shape 122 of the second finger. It is determined that the angle θ is below than zero, and the touch-sensitive region 12 may send an indication of the angle θ and/or the right hand to the processor of the electronic device. Although the angle determination with respect to the long axis of the ellipse is illustrated, this is only for illustration without suggesting any limitations as to the scope of the subject matter described here. In an example, a short axis of the ellipse may be used to determine which hand is used and the tilt degree of a finger with respect to a direction, such as the vertical direction.

FIG. 6 illustrates a transition from a menu 1021 to a submenu 1023 for handwriting according to an embodiment of the subject matter described herein. In an embodiment, a submenu may be provided to achieve a more powerful function for quick menu selection.

In certain circumstances, some users may have difficulty in typing certain words of a language (often Asian languages) with keys, but the user knows how to handwrite these words. In this case, the user conventionally needs to find out how to type these words with a dictionary or divert to a writing pad, and it takes a lot of time.

In FIG. 6, it is illustrated a convenient approach to quickly input these words with schematically illustrating transition from a menu to a submenu for handwriting. The menu 1021 is configured to have a menu item of handwrite 1022.

The keyboard 10 may send an indication of selection to the processor of the electronic device. The processor may receive the indication of selection, and select the menu item of handwrite 1022 in response to receiving the indication of selection.

In response to selecting the menu item of “handwrite” 1022, the processor may cause the display of the electronic device to display a submenu 1023. The submenu 1023 may be displayed completely or partially overlaying the menu 1021. In response to displaying the submenu 1023, the user may use the touch-sensitive region to handwrite.

Traces of the touch of finger or stylus may be dynamically displayed on the submenu 1023. In case that the handwriting is finished, the user may press a predetermined key, such as the “ESC” key, to end this handwriting. In addition, the user may press another predetermined key to return to the menu for reselecting the handwriting.

In response to receiving the indication of completion or an indication of returning from the keyboard 10, the processor may cause the display to present the correct word at the cursor or present a series of candidate words for selection based on the handwriting. In case that the correct word is determined, the processor may cause the display not to display the menu 1021 and the submenu 1023.

Although handwriting for inputting difficult words is illustrated, this is only for illustration without suggesting any limitations as to the scope of the subject matter described here. Other approaches may be applied. For example, the function of handwrite may be used for inputting a digital signature or simple freehand sketching.

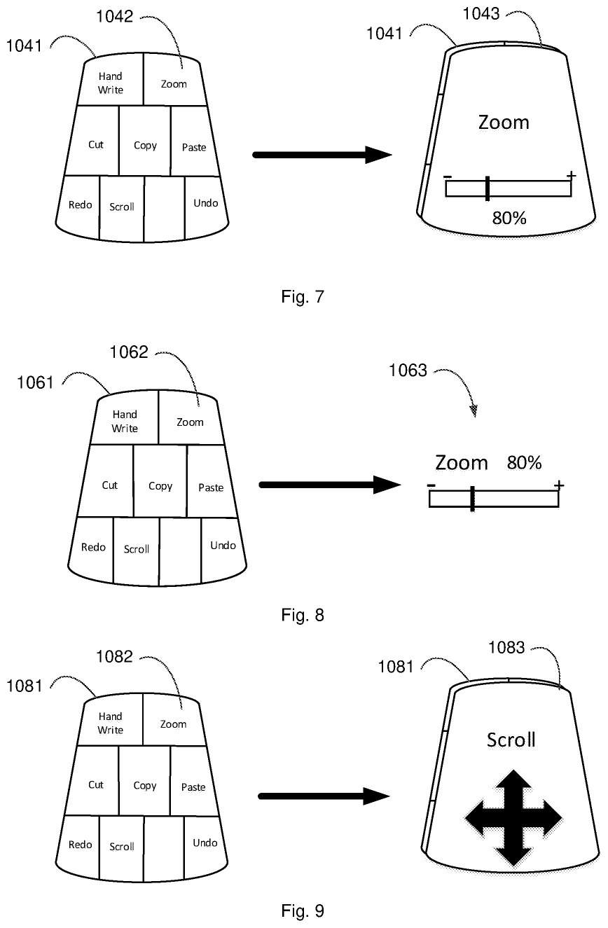

FIG. 7 illustrates a transition from a menu 1041 to a submenu 1043 for zooming according to an embodiment of the subject matter described herein. In an embodiment, the user may intend to zoom in or zoom out current view of an application or software, such that the user may obtain detail of certain region of the view or a full picture of the application or software.

The menu 1041 is configured to have a menu item of “zoom” 1042. In response to selecting the menu item of zoom 1042, the processor may cause a submenu 1043 displayed completely or partially overlaying the menu 1041. The shape of the submenu 1043 is the same as the shape of the menu 1041.

In an example, a percentage and a scale bar may be displayed inside the profile of the submenu 1043. In response to displaying the submenu 1043, the user may use the touch-sensitive region to perform the zooming function.

In case that the user moves the finger to the left, the scale bar will move to the left with the percentage number varying accordingly, and the view will be zoomed out. In case that the user moves the finger to the right, the scale bar will move to the right with the percentage number varying accordingly, and the view will be zoomed in.

Although FIG. 7 illustrates an approach for zooming, this is only for illustration without suggesting any limitations as to the scope of the subject matter described here. Other approaches may be applied. For example, FIG. 8 illustrates another transition from a menu 1061 to a submenu 1063 for zooming according to an embodiment of the subject matter described herein. Instead of displaying the profile of the submenu 1043, the percentage number and the scale bar, only the scale bar and the percentage number are displayed for the submenu 1063. In this case, the menu 1061 may not be displayed in response to displaying the submenu 1063.

This configuration of FIG. 8 is feasible, because movement in one dimension needs to be measured for performing the function of zooming. In addition, the configuration of FIG. 8 is more succinct as compared to the configuration of FIG. 7 due to lack of the profile of the submenu 1043.

In another example, the touch-sensitive region may detect multiple touches. In this case, a distance between touch points of two fingers may be enlarged to zoom in the view, and the distance may be shortened to zoom out the view.

FIG. 9 illustrates a transition from a menu 1081 to a submenu 1083 for moving or scrolling according to an embodiment of the subject matter described herein. In an embodiment, the user may intend to move or scroll current view of an application or software, such that the user may observe certain region of the application or software. The menus 1081 is configured to have a menu item of “scroll” 1082.

In response to selecting the menu item of “scroll” 1082, the processor may cause a submenu 1083 displayed completely or partially overlaying the menu 1081. The shape of the submenu 1083 is the same as the shape of the menu 1081. In an example, a cross arrow and an indicator of “scroll” are displayed inside the profile of the submenu 1083. In response to displaying the submenu 1083, the user may use the touch-sensitive region to perform the moving or scrolling function.

In case that the user moves the finger to the left, the view of the application or software will move to the left accordingly. In case that the user moves the finger to the right, the view of the application or software will move to the right accordingly. In case that the user moves the finger upward or downward, the view of the application or software will move upward or downward accordingly.

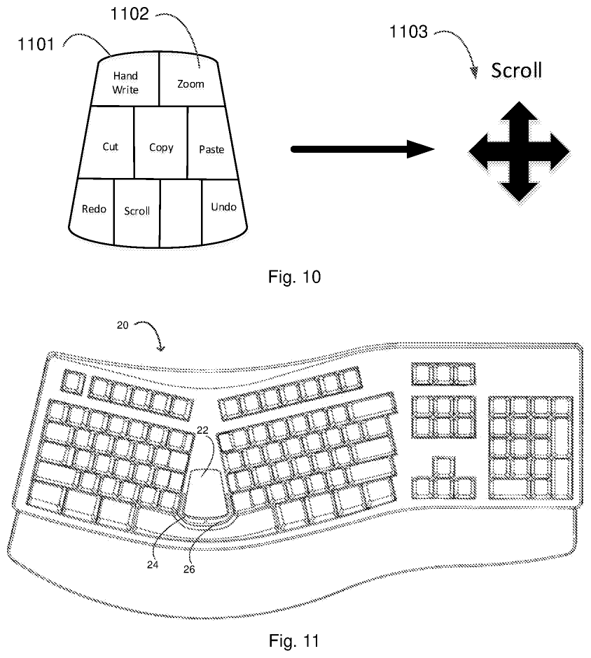

Although FIG. 9 illustrates an approach for scrolling or moving, this is only for illustration without suggesting any limitations as to the scope of the subject matter described here. Other approaches may be applied. For example, FIG. 10 illustrates another transition from a menu 1101 to a submenu 1103 for scrolling or moving according to an embodiment of the subject matter described herein.

Instead of displaying the profile of the submenu 1083, the cross arrow and the indicator of “scroll”, only the cross arrow and the indicator of “scroll” are displayed for the submenu 1103. The configuration of FIG. 10 is more succinct as compared to the configuration of FIG. 9 due to lack of the profile of the submenu 1083.

Although several examples have been described for the submenu, they are only for illustration without suggesting any limitations as to the scope of the subject matter described here. Other approaches may be applied. For example, the menu and the submenu may be both customized, and the menu items of the menu and the submenu may be assigned to different functions by customization. In another example, a menu item at a certain location of a menu or a submenu may be assigned to different functions depending on applications and software.

Although two-stage menu system including a menu and a submenu is illustrated, this is only for illustration without suggesting any limitations as to the scope of the subject matter described here. The menu system may be customized with more than two stages. For example, a submenu may be configured to have a sub-submenu as needed.

FIG. 11 illustrates a keyboard 20 with first and second sensors 24 and 26 according to an embodiment of the subject matter described herein. The keyboard 20 includes additional proximity sensors 24 and 26, as compared to the keyboard 10.

For example, the first sensor 24 is an proximity sensor, and is arranged adjacent to a first side of the touch-sensitive region 22 and configured to detect a first finger of a first hand on or above the first sensor 24 and in response to detecting the first finger send an indication of the first hand to the electronic device.

For example, the second sensor 26 is also an proximity sensor, and is adjacent to a second side of the touch-sensitive region 22 and configured to detect a second finger of a second hand on or above the second sensor 26 and in response to detecting the second finger send an indication of the second hand to the electronic device.

In certain circumstances, it needs to know which hand is used. For example, in case that the translucent indicator of a finger is displayed, fingers of left and right hands may have different orientations. To more accurately demonstrate touch condition of a finger, it needs to correctly show which hand is used.

The proximity sensors 24 and 26 can be used to detect which hand is on the touch-sensitive region during menu selection operation. For example, in case that a finger of the first hand touches the touch-sensitive region 22, the proximity sensor 24 detects a part of the finger hanging over the proximity sensor 24.

The proximity sensor 24 may thus send an indication of the first hand to the electronic device, and an indicator of a finger orienting in a first direction will be showed. For example, the first hand is the left hand, and the first direction is top right. Analogous operation may apply to the proximity sensor 26 for the second hand.

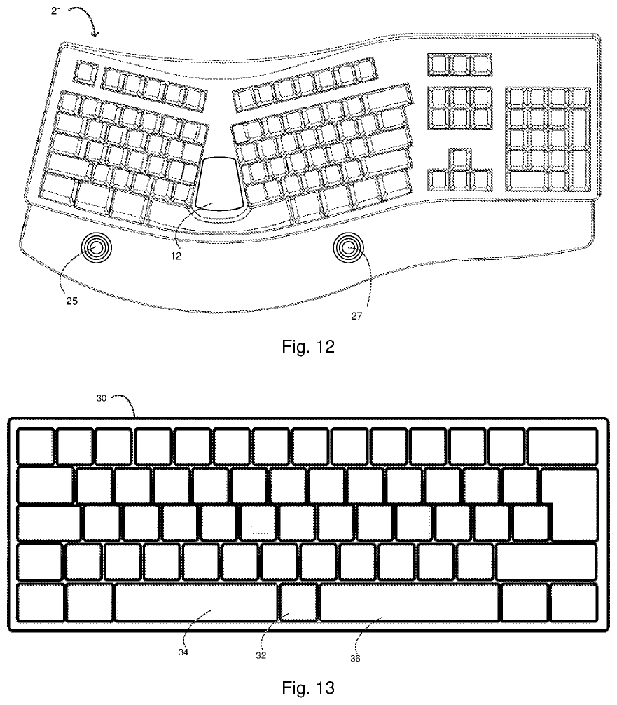

FIG. 12 illustrates a keyboard 21 with turntable mechanisms 25 and 27 according to an embodiment of the subject matter described herein. As an alternative to the proximity sensors 24 and 26, the turntable mechanisms 25 and 27 may be used to detect which hand is used.

In case that a finger of a first hand is used, the wrist of the first hand may locate on the turntable mechanism 25. The user may rotate the wrist of the first hand to a certain degree, and the turntable mechanism 25 may rotate a corresponding degree. In response to rotating a predetermined degree, the turntable mechanism 25 may send an indication of the first hand to the electronic device, and an indicator of a finger orienting in a first direction will be showed.

In an example, the first hand is the left hand, and the first direction is top right. The first turntable mechanism 25 is arranged at the left bottom of the keyboard 21, and operable to detect rotation of a first wrist of a first hand on the first turntable mechanism 25, and in response to detecting the rotation of the first wrist send an indication of the first hand to the electronic device. Analogous operation may apply to the turntable mechanism 27 for the second hand.

In another example, the turntable mechanisms 25 and 27 may be used to initiate display of the menu. In response to rotating a predetermined degree, the turntable may send an indication of initialization to the electronic device to cause the electronic device to display the menu. In response to receiving the indication of initialization, the processor causes the electronic device enters a menu selection mode from a typing mode, and causes the electronic device to display the menu. In addition, an indicator of finger with a correct orientation may be displayed.

In addition, the turntable mechanisms 25 and 27 may make a sound of “click” to indicate that the predetermined degree has been reached. Alternatively, the turntable mechanisms 25 and 27 may each have a stopper for the predetermined degree. In case that the turntable mechanism rotates the predetermined degree, the stopper stops the rotation, and an indication of at least one of menu initialization and which hand is used may thus be sent to the electronic device.

Although several embodiments with respect to ergonomic keyboard have been described above, this is only for illustration without suggesting any limitations as to the scope of the subject matter described here. Other keyboards may be applied. FIG. 13 illustrates another keyboard 30 according to an embodiment of the subject matter described herein.

The keyboard 30 includes a touch-sensitive region formed by a plurality of keys. The keys in the touch-sensitive region may have capability of detecting a touch of a finger, a stylus or other objects. In another example, the touch-sensitive region may have capability of detecting multiple touches. Thus, some functions, such as zooming, may be achieved with multiple touches.

The touch-sensitive region includes a left space key 34, a right space key 36, and a menu key 32 arranged between the left and right space keys 34 and 36. By setting the menu key 32 between the left and right space keys 34 and 36, the user may conveniently and quickly initiate the touch-sensitive region with a finger, such as a thumb, without looking at the touch-sensitive region and moving an entire hand.

The menu key 32 may be configured to detect a press on the menu key 32. In response to detecting the press, the menu key 32 may send an indication of initialization to an electronic device. In response to receiving the indication of initialization, the processor of the electronic device may cause the electronic device to enter a menu selection mode from a typing mode. The electronic device may display a menu on a view of an application or software in response to receiving the indication of initialization.

In another example, a predetermined gesture, such as a slide from the left space key 34, through the menu key 32, to the right space key 36, may be used to send an indication of initialization to an electronic device. Alternatively, simultaneous presses for the left and right space keys 34 and 36 may be used to send an indication of initialization to an electronic device.

In another example, the touch-sensitive region 38 may detect a predetermined gesture, such as a tap or a swipe with two or more fingers on or above the touch-sensitive region 38, and the touch-sensitive region 38 may send an indication of initialization to the electronic device in response to detecting the predetermined gesture.

In response to receiving the indication of initialization, the processor of the electronic device may cause the electronic device to enter a menu selection mode from a typing mode, and displays the menu on the view of the application or software.

Although two approaches for initializing the menu have been illustrated, this is only for illustration without suggesting any limitations as to the scope of the subject matter described here. Other approaches may be applied. For example, a predetermined key combination, for example a combination of “Windows+Z”, may be used to initialize display of the menu on the view of the application or software. In this case, the menu key may not be necessary.

In another example, the keyboard 30 may be configured to include proximity sensors or turntables to send the indication of initialization. The proximity sensors or turntables may operate in a manner similar to the proximity sensors 24 and 26, and the turntable mechanisms 25 and 27. Thus, the description for their operation is omitted here for brevity.

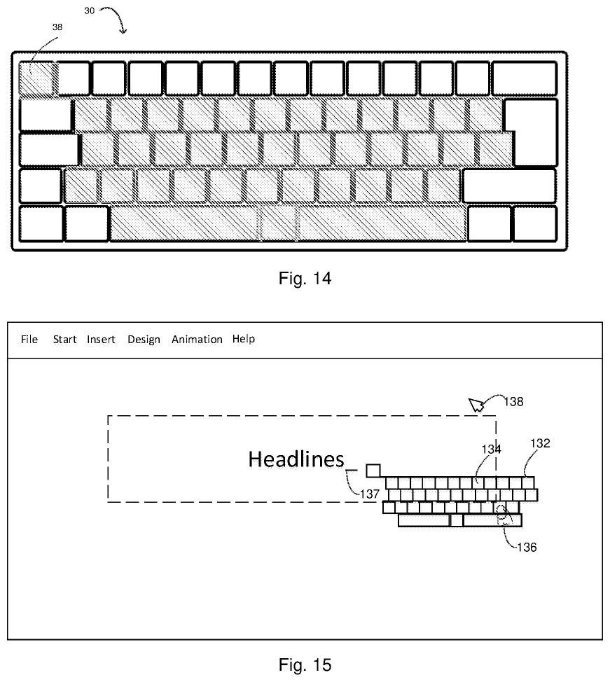

FIG. 14 illustrates the touch-sensitive region 38 of keyboard 30 of FIG. 13 according to an embodiment of the subject matter described herein. The touch-sensitive region 38 may be formed by a plurality of touch-sensitive keys, and may be configured based on keys having touch-sensitive capability. In an example, the user may select keys from the keys having touch-sensitive capability to customize a shape of the touch-sensitive region 38.

Detection for a touch on or above the touch-sensitive region 38 is similar to detection for the touch on or above the touch-sensitive region 12. The touch-sensitive region 38 is configured to detect a touch on or above the touch-sensitive region 38. In another example, the touch-sensitive region 38 may detect a plurality of touches of fingers or objects on the touch-sensitive region 38 such that some functions may be performed with multiple touches.

The touch-sensitive region 38 may detect touch shape and area on the touch-sensitive region 38, such that the touch-sensitive region 38 may determine which hand is used. For example, the touch-sensitive region 38 may detect the position of the touch, and send the indication of the position of the touch to the processor in real time. In the example, the position of the touch may include a touch shape (profile of the touch of the finger), such that the processer may determine which hand is used and/or the tilt degree of the translucent indicator of the finger, as described with reference to FIG. 5.

The touch-sensitive region 38 may have an absolute pointing mode to detect absolute X/Y position of the touched point in real time. The touch-sensitive region 38 may then send an indication of the position of the touch to an electronic device to cause the electronic device to select a menu item of a menu on a display of the electronic device based on the position of the touch. The electronic device may include a computer, a laptop, a tablet, and other electronic devices having a display.

FIG. 15 illustrates an application or software including another menu 132 according to an embodiment of the subject matter described herein. In response to receiving the indication of the position of the touch from the touch-sensitive region 38, the processor of the electronic device may cause the display to display a menu 132 including a plurality of menu items. The menu 132 may float over the view of the application or the software. The shape of the menu 132 matches the shape of the touch-sensitive region 38, and the size of the menu 132 may be proportional to the size of the touch-sensitive region 38.

In an example, the menu 132 comprises a plurality of blocks. Each block may be customized with a menu item, and may correspond to a key of the touch-sensitive region. In an example, some of the blocks may be customized to have menu items, and other blocks may be left unused.

In case that a user touches a key of the touch-sensitive region in the menu selection mode, the position of the touch is detected by the touch-sensitive region 38. The indication of the position of the touch is sent to the processor of the electronic device. The electronic device may highlight a corresponding area of the menu 132 with a color different from other areas, a translucent indicator 136, or a combination thereof, in response to receiving the indication of the position.

In case that a user touches a plurality of keys of the touch-sensitive region in the menu selection mode, and a touch of only one key is desired, the keyboard 30 may send the position of the most recently touched key as the desired position of the touch to the electronic device. Alternatively, the keyboard 30 may send the position of the touch at the farthest key from keyboard center position (the keys “G” and “H”) or from a predetermined key, such as the key “Home”.

In case of multiple touches, the menu item corresponding to the desired position of the touch is highlighted with a first color, different from color of the menu items corresponding to untouched keys. Other menu items corresponding to other touched keys may be highlighted with a second color lighter than the first color to illustrate that a plurality of touches are detected. Thus, the user may notice, and take unnecessary fingers away from the keyboard 30.

The menu items may be customized or assigned to various functions, depending on the application or software being used. For example, the menu item 134 may be assigned to the “File” function for a first application or software, but it may be assigned to “Undo” function for a second application or software. By customization, the user may choose frequently used functions for certain menu items.

The menu 132 may also include an indicator 136, such as an indicator of a finger, to highlight the currently focused menu item. Alternatively, a cross bar, a different color, or a combination of the different color and the finger or the cross bar may be used to highlight the currently focused menu item.

In an example, the menu 132 is configured to locate at or near an input cursor 137 or a mouse cursor 138. By locating the menu at or near an input cursor 137 or a mouse cursor 138, it may significantly reduce eye movement, such that the user needs not to divert his or her sight, and operation with the keyboard 30 will be faster and more convenient.

Because the keyboard 30 has the touch-sensitive region 38, operations with respect to FIGS. 5-10 may also apply to the keyboard 30. In an example, the keyboard 30 detects a press or double-clicks on the touch-sensitive region 38. The keyboard 30 sends an indication of selection to the electronic device. Alternatively, a predetermined key may be pressed to send the indication of selection.

The processor of the electronic device may receive the indication of the selection. In case that a menu item is selected, the processor performs a corresponding function, and the menu selection may be completed. In an example, the processor of the electronic device automatically causes the display not to display the menu in response to selecting the menu item. In another example, the processor may receive an indication of completion from the keyboard, and the processor may cause the display not to display the menu in response to receiving the indication of completion.

By using the customized menu matching the touch-sensitive region of the keyboard, users can significantly improve menu selection efficiency, without memorizing conventional shortcut key combinations or operating another device, such as a mouse, to select menu items. All the operations may be done at the keyboard with a minimum movement of hand, and the user may need not to look at the keyboard, because the touch-sensitive region is arranged at a convenient place, such as a place between the left and right space keys. The user may find the touch-sensitive region depending on “muscle memory” or “spatial memory”, without looking at the keyboard.

By using absolute pointing mode along with the user's “muscle memory” or “spatial memory”, the user can directly reach targeted menu items without lengthily moving mouse pointer from the current pointer position to the targeted menu items by sliding fingers, because the (well-trained) user knows the position of the targeted menu item on the trackpad. If needed, the user can also adjust targeted menu item by sliding fingers after initial pointing.

Although various embodiments with respect to a physical keyboard have been described above, this is only for illustration without suggesting any limitations as to the scope of the subject matter described here. Virtual keyboards displayed on a touch screen of an electronic device may also apply.

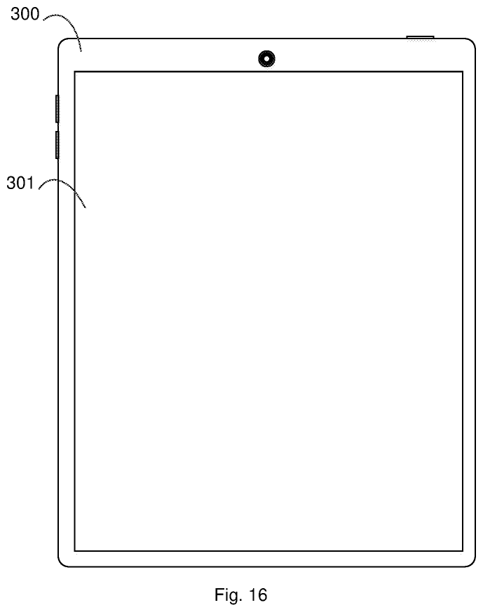

FIG. 16 illustrates an electronic device 300 according to an embodiment of the subject matter described herein. The electronic device 300 may include a touch-sensitive screen 301 for displaying contents and inputting with a virtual keyboard. The touch-sensitive screen 301 may determine force of a touch in certain modes, such as the menu selection mode.

For example, in the menu selection mode, a touch with a light force is determined to correspond to a normal touch, and a touch with a heavy force is determined to correspond to a normal press for a key. Although two degrees of force are described, this is only for illustration without suggesting any limitations as to the scope of the subject matter described here. For example, it may adopt three or more degrees of forces to perform different functions.

The touch-sensitive screen 301 may detect a touch on or above the touch-sensitive 301, and determine the position of the touch in response to detecting the touch on or above the touch-sensitive 301. The electronic device 300 may include tablet, a laptop with a touch screen, and other electronic devices with a touch screen.

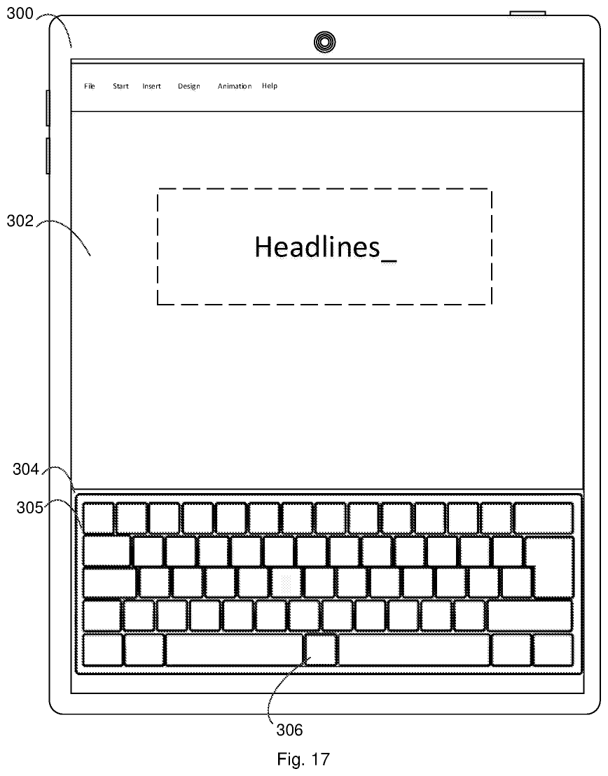

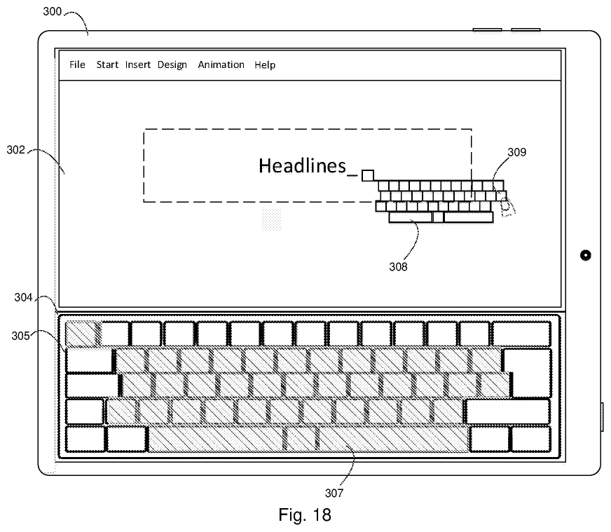

FIG. 17 illustrates the electronic device 300 of FIG. 16 displaying a virtual keyboard 305 according to an embodiment of the subject matter described herein. In an environment of an application or software, the touch-sensitive screen 301 may have a content region 302 and a keyboard region 304 in case of inputting.

The content region 302 may display the content of an application or software. The keyboard region 304 may display a virtual keyboard 305 for inputting. The virtual keyboard 305 may have a configuration similar to the keyboard 30. Operation on the virtual keyboard 305 is similar to the operation on the keyboard 30.

The virtual keyboard 305 includes a touch-sensitive region formed by a plurality of keys to detect a touch. In another example, the touch-sensitive region may have capability of detecting multiple touches. Thus, some functions, such as zooming, may be achieved with multiple touches.

The touch-sensitive region includes a left space key, a right space key, and a menu key 306 between the left and right space keys. By setting the menu key 306 between the left and right space keys, the user may conveniently and quickly initiate the touch-sensitive region with a finger, such as a thumb, without looking at the touch-sensitive region and moving an entire hand.

The menu key 306 may be configured to detect a press on the menu key 306. In response to detecting the press, the touch-sensitive screen may send an indication of initialization to the electronic device 300. In response to receiving the indication of initialization, the electronic device 300 may enter a menu selection mode from the typing mode, and displays a menu on a view of an application or software.

In another example, a predetermined gesture, such as a slide from the left space key, through the menu key 306, to the right space key, may be used to send the indication of initialization, and the electronic device 300 may enter a menu selection mode from the typing mode, and displays the menu in the content region 302.

Although two approaches for initializing the menu have been illustrated, this is only for illustration without suggesting any limitations as to the scope of the subject matter described here. Other approaches may apply. For example, a predetermined key combination may be used to initialize display of the menu on the view of the application or software. In this case, the menu key may not be necessary.

In an example, the user may select keys from the virtual keyboard 305 to customize a shape of the touch-sensitive region. In case the keys are selected, a shape of the menu will be adjusted based on the shape of the touch-sensitive region.

Detection for a touch on or above the touch-sensitive region of the virtual keyboard 305 is similar to detection for the touch on or above the touch-sensitive region 38. The touch-sensitive screen 301 is configured to detect a touch on or above the touch-sensitive region. The touch-sensitive screen 301 may detect a touch of a finger, a stylus or other objects on the touch-sensitive region.

In another example, the touch-sensitive screen 301 may detect touch shape and area on the touch-sensitive region such that the touch-sensitive screen 301 may determine which hand is used. For example, the touch-sensitive screen 301 may determine an ellipse shape of a finger, and determine which hand is used based on the long axis orientation of the ellipse shape.

The touch-sensitive screen 301 may have an absolute pointing mode to detect absolute X/Y position of the touched point in real time. The touch-sensitive screen 301 may then send an indication of the position of the touch to the processor of the electronic device 300, and the processor causes the electronic device 300 to select a menu item of a menu on the touch-sensitive screen 301 based on the position of the touch.

FIG. 18 illustrates the electronic device 300 of FIG. 16 displaying a virtual keyboard 305 according to another embodiment of the subject matter described herein. The content displayed in the content region 302 is similar to that of FIG. 15.

In response to receiving the indication of the position of the touch from the touch-sensitive screen 301, the content region of the touch-sensitive screen 301 may display a menu including a plurality of menu items. The menu may float over the view of the application or the software. The shape of the menu matches the shape of the touch-sensitive region 307.

In an example, the menu comprises a plurality of configurable menu items in a plurality of blocks to match respective key regions of the touch-sensitive region. Each block may be customized with a menu item, and may correspond to a key of the touch-sensitive region. In an example, some of the blocks may be customized to have menu items, and other blocks may be left unused.

In case that a user touches a key of the touch-sensitive region in the menu selection mode, the position of the touch is detected by the touch-sensitive screen 301. The indication of the position of the touch is sent to the processor of the electronic device 300. The processor causes the touch-sensitive screen 301 to highlight a corresponding area of the menu with a color different from other areas, a translucent indicator, or a combination thereof, in response to receiving the indication of the position.

Each of the menu items may be customized or assigned to various functions, depending on the application or software being used. By customization, the user may choose frequently used functions for certain menu items.

In an example, the menu may include an indicator, such as an indicator of a finger, to highlight the currently focused menu item. Alternatively, a cross bar, a different color, or a combination of the different color and the finger or the cross bar may be used to highlight the currently focused menu item.

In an example, the menu is configured to locate at or near an input cursor or a mouse cursor. By locating the menu at or near an input cursor or a mouse cursor, it may significantly reduce eye movement, such that the user needs not to divert his or her sight, and operation with the virtual keyboard 305 will be faster and more convenient. Because the virtual keyboard 305 has the touch-sensitive region, operations with respect to FIGS. 5-10 may also apply to the virtual keyboard 305. Thus, the description for operation on the virtual keyboard 305 with respect to FIGS. 5-10 is omitted here for brevity.

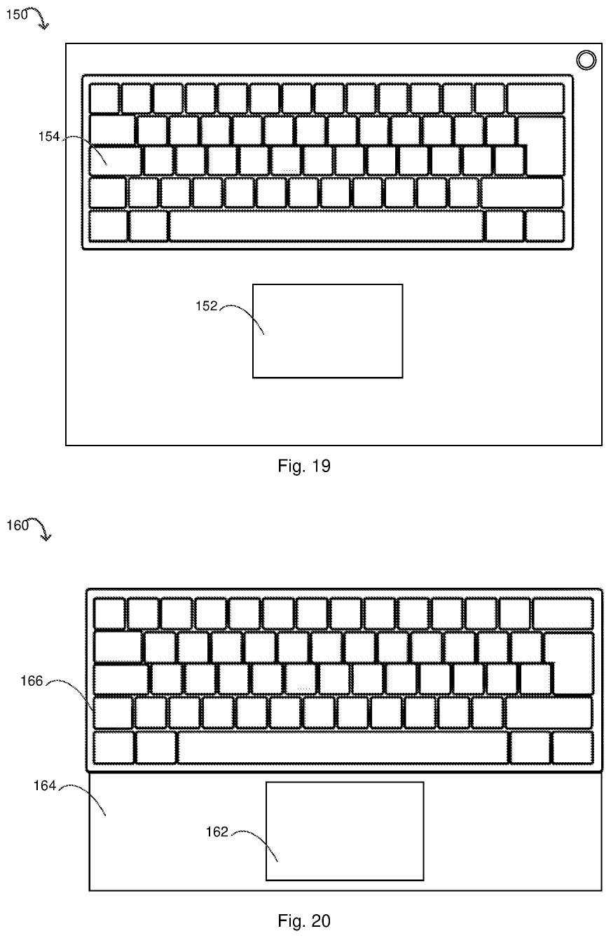

FIG. 19 illustrates a keyboard 150 for a laptop according to an embodiment of the subject matter described herein. The keyboard 150 comprises a conventional key region 154 and a touch-sensitive region 152. In an example, the touch-sensitive region 152 may be a track pad on a conventional laptop.

The touch-sensitive region 152 may be configured in a similar manner as the touch-sensitive region 12. Analogous operations for the touch-sensitive region 12 may apply to the touch-sensitive region 152. For example, the touch-sensitive region 152 may detect a touch on or above the touch-sensitive region 152, a press or double-clicks on the touch-sensitive region 152, a predetermined gesture such as a tap or a swipe of two or more fingers on or above the touch-sensitive region 152.

In response to detecting the press or double-clicks on the touch-sensitive region 152, a predetermined gesture such as a tap or a swipe of two or more fingers, or a predetermined key combination such as “Windows+Z”, the keyboard 150 may send an indication of initialization to a processor of the laptop.

The processor may cause the laptop to display a configurable or customized menu for an application or software in response to receiving the indication of initialization. A shape of the configurable or customized menu matches a shape of the touch-sensitive region 152, and the menu items of the menu correspond to different sub-regions of the touch-sensitive region 152.

The touch-sensitive region 152 may detect the position of the touch, and send the indication of the position of the touch to the processor in real time. In an example, the position of the touch may include a touch shape, such that the processer may determine which hand is used and/or the tilt degree of the translucent indicator of the finger, as described with reference to FIG. 5.

In addition, the touch-sensitive region 152 may detect multiple touches, and the processor, in response to receiving the positions of the multiple touches, may perform some multiple touch functions, such as the zooming in and out function as described with reference to FIGS. 7 and 8.

In response to receiving the indication of the position of the touch, the processor may cause the menu items highlighted accordingly with an indicator of a translucent finger or a cross and/or a different color, as described with reference to FIG. 4. As such, the user may acknowledge on which item is focused.

The touch-sensitive region 152 may also send an indication of selection to the processor in response to detecting the press or double-clicks on the touch-sensitive region 152, a predetermined gesture such as a tap or a swipe of two or more fingers, or a predetermined key or key combination such as “Enter”. In response to receiving the indication of selection, the processor may perform a function represented by the selected menu item.

The processor may automatically complete the menu selection in response to performing the function. Alternative, the processor may complete the menu selection in response to receiving an indication of completion from the keyboard 150. The indication of completion may be triggered by pressing a predetermined key or key combination such as pressing the key “ESC”, detecting the press or double-clicks on the touch-sensitive region 152, or detecting a predetermined gesture such as a tap or a swipe of two or more fingers.

FIG. 20 illustrates a keyboard 160 with a palm-rest component 164 according to an embodiment of the subject matter described herein. The palm-rest component 164 may be provided independently from the key region 166, and the key region 166 may be a conventional keyboard.

In an example, the palm-rest component 164 may be adapted to mount to the key region 166 via an interface (not shown) for mechanical coupling and transmitting data generated by the touch-sensitive region 162. In another example, palm-rest component 164 may be adapted to mount to the key region 166 with a mechanical structure, and the palm-rest component 164 may transmit the data via a separate interface.

Although the palm-rest component 164 and the key region 166 are illustrated to be separate components, this is only for illustration without suggesting any limitations as to the scope of the subject matter described here. In an example, the palm-rest component 164 may be provided integrally with the key region 166.

The palm-rest component 164 may include a built-in touch-sensitive region 162, such as a track pad. The track pad may operate in a similar manner to the touch-sensitive regions 12 and 152. As such, analogous operations for the touch-sensitive regions 12 and 152 may apply to the touch-sensitive region 162. Description for the keyboard 160 including the touch-sensitive region 162 is omitted here for brevity.

In another example, the palm-rest component 164 may include proximity sensors or turntable mechanisms. The proximity sensors of the palm-rest component 164 may operate in a similar manner to the proximity sensors 24 and 26, and the turntable mechanisms of the palm-rest component 164 may operate in a similar manner to the turntable mechanisms 25 and 27. Thus, description for the proximity sensors or turntable mechanisms of the palm-rest component 164 is omitted here for brevity.

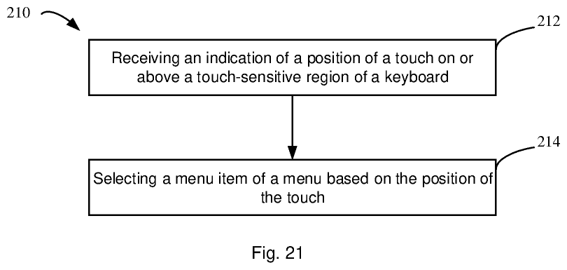

FIG. 21 illustrates a computer-implemented method 210 for selecting a menu item with a keyboard according to another embodiment of the subject matter described herein. It should be understood that the computer-implemented method 210 may also comprise additional steps not shown and/or omit the illustrated steps. Scope of the subject matter described herein is not limited in this aspect.

At 212, it is received an indication of a position of a touch on or above a touch-sensitive region of a keyboard. For example, a processor of the computer 600 may receive the indication of the position of the touch. The indication of the position of the touch may be generated by the keyboard 10, 20, 21, 30, or the virtual keyboard 305.

At 214, it is selected a menu item of a menu based on the position of the touch. For example, the processor of the computer 600 may select the menu item in response to receiving the indication of the positon of the touch. The menu including the menu item is presented on the display. The shape of the menu matches the shape of the touch-sensitive region of the keyboard. It is to be understood that all features about the keyboard 10, 20, 21, 30, or the virtual keyboard 305 as described above with reference to FIGS. 2 to 20 apply to the menu selection method, which will not be detailed here.

Hereinafter, some example implementations of the subject matter described herein will be listed.

Item 1: There is provided a keyboard. The keyboard comprises a touch-sensitive region. The touch-sensitive region is configured to in response to detecting a touch on or above the touch-sensitive region, determine the position of the touch, and send an indication of the position of the touch to an electronic device to cause the electronic device to select a menu item of a menu based on the position of the touch. The menu is presented on a display of the electronic device. A shape of the menu matches a shape of the touch-sensitive region.

Item 2: According to the keyboard of Item 1, the keyboard further comprises a left key region and a right key region. The touch-sensitive region is a touch pad arranged between the left and right key regions.

Item 3: According to the keyboard of Item 1 or 2, the touch-sensitive region comprises a plurality of touch-sensitive keys including a menu key. The menu key is arranged between a left space key and a right space key of the touch-sensitive keys.

Item 4: According to the keyboard of any of Items 1-3, the touch-sensitive region is further configured to in response to detecting a press on the menu key or a predetermined gesture on or above the touch-sensitive region, send an indication of initialization to the electronic device to cause the electronic device to display the menu.

Item 5: According to the keyboard of any of Items 1-4, the touch-sensitive region is further configured to in response to detecting the press or the predetermined gesture on or above the touch-sensitive region, send an indication of initialization to the electronic device to cause the electronic device to display the menu.

Item 6: According to the keyboard of any of Items 1-5, the keyboard is operable to in response to pressing a predetermined key of the keyboard, send an indication of completion to the electronic device to cause the electronic device not to display the menu.

Item 7: According to the keyboard of any of Items 1-6, the keyboard further comprises a first sensor and a second sensor. The first sensor is adjacent to a first side of the touch-sensitive region and configured to detect a first finger of a first hand on or above the first sensor and in response to detecting the first finger send an indication of the first hand to the electronic device. The second sensor is adjacent to a second side of the touch-sensitive region and configured to detect a second finger of a second hand on or above the second sensor and in response to detecting the second finger send an indication of the second hand to the electronic device.

Item 8: According to the keyboard of any of Items 1-7, the keyboard further comprises a first turntable mechanism and a second turntable mechanism. The first turntable mechanism is arranged at the left bottom of the keyboard, and operable to detect rotation of a first wrist of a first hand on the first turntable mechanism and in response to detecting the rotation of the first wrist send an indication of the first hand to the electronic device. The second turntable mechanism is arranged at the right bottom of the keyboard, and operable to detect rotation of a second wrist of a second hand on the second turntable mechanism and in response to detecting the rotation of the second wrist send an indication of the second hand to the electronic device.

Item 9: According to the keyboard of any of Items 1-8, the touch-sensitive region is further configured to determine a shape of the touch, and send an indication of the shape to the electronic device.

Item 10: There is provided a computer implemented method. The method comprises receiving an indication of a position of a touch on or above a touch-sensitive region of a keyboard and selecting a menu item of a menu based on the position of the touch, the menu presented on a display of an electronic device. A shape of the menu matches a shape of the touch-sensitive region.

Item 11: According to the method of Item 10, the menu comprises a plurality of menu items matching respective sub-regions or keys of the touch-sensitive region.

Item 12: According to the method of Item 10 or 11, the menu item is configured to correspond to different functions based on applications or software.

Item 13: According to the method of any of Items 10-12, the method further comprises in response to selecting the menu item of the menu, causing the display of the electronic device to display a submenu completely or partially overlaying the menu.

Item 14: According to the method of any of Items 10-13, causing the display of the electronic device to display the submenu includes displaying a handwriting image at the submenu to depict handwriting at the touch-sensitive region.

Item 15: According to the method of any of Items 10-14, causing the display of the electronic device to display the submenu includes zooming in or out a view of applications or software based on a zoom gesture at the touch-sensitive region.

Item 16: According to the method of any of Items 10-15, causing the display of the electronic device to display the submenu includes moving a view of applications or software based on a moving gesture at the touch-sensitive region.

Item 17: According to the method of any of Items 10-16, the menu includes a translucent indicator of a finger or a cross on the menu to indicate the position of the touch at the touch-sensitive region.

Item 18: According to the method of any of Items 10-17, the menu is configured to locate at or near an input cursor or a mouse cursor.

Item 19: According to the method of any of Items 10-18, the method comprises receiving an indication of initialization. The method further comprises in response to receiving the indication of initialization, causing the display to display the menu.

Item 20: According to the method of any of Items 10-19, the method comprises in response to selecting the menu item, causing the display not to display the menu.

Item 21: According to the method of any of Items 10-20, the method comprises receiving an indication of completion. The method further comprises in response to receiving the indication of completion, causing the display not to display the menu.

Item 22: According to the method of any of Items 10-21, the method comprises receiving an indication of a first hand. The method further comprises in response to receiving the indication of the first hand, causing the display to display a first translucent indicator of a first finger of the first hand on the menu.

Item 23: According to the method of any of Items 10-22, the method comprises receiving an indication of a second hand. The method further comprises in response to receiving the indication of the second hand, causing the display to display a second translucent indicator of a second finger of the second hand on the menu.

Item 24: According to the method of any of Items 10-13, the method comprises receiving an indication of a shape of the touch, and in response to receiving the indication of the shape of the touch, causing the display to present the translucent indicator of the finger based on the indication of the shape of the touch.

Item 25: There is provided an electronic device. The electronic device comprises a keyboard of the first aspect, a display, and a processor configured to perform the method of the second aspect.

Item 26: There is provided an electronic device. The electronic device comprises a touch-sensitive screen. The touch-sensitive screen is configured to display a virtual keyboard including a touch-sensitive region. The touch-sensitive screen is further configured to in response to detecting a touch on or above the touch-sensitive region of the touch-sensitive screen, determine the position of the touch. The touch-sensitive screen is further configured to send an indication of the position of the touch to a processor of the electronic device to cause the electronic device to select a menu item of a menu based on the position of the touch, the menu presented on the touch-sensitive screen of the electronic device. A shape of the menu matches a shape of the touch-sensitive region.

Item 27: According to the electronic device of Item 26, the virtual keyboard comprises a left key region and a right key region. The touch-sensitive region is arranged between the left and right key regions.

Item 28: According to the electronic device of Item 26 or 27, the touch-sensitive region comprises a plurality of touch-sensitive keys including a menu key arranged between a left space key and a right space key of the touch-sensitive keys.

Item 29: According to the electronic device of any of Items 26-28, the touch-sensitive screen is further configured to in response to detecting a press on the menu key or a predetermined gesture on or above the touch-sensitive screen, such as a slide from left space key to the right space key, send an indication of initialization to the processor of the electronic device to cause the touch-sensitive screen to display the menu.

Item 30: According to the electronic device of any of Items 26-29, the touch-sensitive screen is further configured to in response to detecting the press or the predetermined gesture on or above the touch-sensitive region, send an indication of initialization to the processor of the electronic device to cause the touch-sensitive screen to display the menu.

Item 31: According to the electronic device of any of Items 26-30, the touch-sensitive screen is configured to in response to detecting a press at a predetermined key of the virtual keyboard, send an indication of completion to the processor of the electronic device to cause the touch-sensitive screen not to display the menu.

Item 32: According to the electronic device of any of Items 26-31, the touch-sensitive screen is further configured to determine a shape of the touch, and send an indication of the shape to the processor of the electronic device.

Various embodiments of the subject matter described herein have been described above. The illustrations above are only for illustration without suggesting any limitations as to scope of the subject matter described herein. Without departing from the scope and spirit of various embodiments as illustrated, many modifications and changes are obvious to those skilled in the art. Selection of the terms used herein is intended to best explain the principle of respective embodiments, actual application, or improvement of technologies in the market, or enable other person of normal skill in the art to understand the embodiments disclosed herein.

What is claimed is:

1. A keyboard (10) comprising:
a touch-sensitive region (12) configured to:
in response to detecting a touch on or above the touch-sensitive region (12), determine the position of the touch; and
send an indication of the position of the touch to an electronic device to cause the electronic device to select a menu item (104) of a menu (102) based on the position of the touch, the menu presented on a display of the electronic device,
wherein a shape of the menu (102) matches a shape of the touch-sensitive region (12).

2. The keyboard of claim 1, further comprising a left key region (13) and a right key region (14), wherein the touch-sensitive region (12) is a touch pad arranged between the left and right key regions (13, 14).

3. The keyboard of claim 1, wherein the touch-sensitive region comprises a plurality of touch-sensitive keys including a menu key (32), the menu key (32) arranged between a left space key (34) and a right space key (36) of the touch-sensitive keys.

4. The keyboard of claim 3, wherein the touch-sensitive region is further configured to:
in response to detecting a press on the menu key (32) or a predetermined gesture on or above the touch-sensitive region, send an indication of initialization to the electronic device to cause the electronic device to display the menu.

5. The keyboard of claim 1, wherein the touch-sensitive region is further configured to:
in response to detecting a press or a predetermined gesture on or above the touch-sensitive region, send an indication of initialization to the electronic device to cause the electronic device to display the menu.

6. The keyboard of claim 1, wherein the keyboard is operable to in response to pressing a predetermined key of the keyboard, send an indication of completion to the electronic device to cause the electronic device not to display the menu.

7. The keyboard of claim 1, wherein the touch-sensitive region is further configured to determine a shape of the touch, and send an indication of the shape to the electronic device.

8. A computer-implemented method (210) comprising:
receiving (212) an indication of a position of a touch on or above a touch-sensitive region of a keyboard; and
selecting (214) a menu item of a menu based on the position of the touch, the menu presented on a display of an electronic device,
wherein a shape of the menu matches a shape of the touch-sensitive region.

9. The computer-implemented method of claim 8, wherein the menu comprises a plurality of menu items matching respective sub-regions or keys of the touch-sensitive region.

10. The computer-implemented method of claim 8, further comprising:
in response to selecting the menu item of the menu, causing the display of the electronic device to display a submenu (110) completely or partially overlaying the menu.

11. The computer-implemented method of claim 8, wherein the menu includes a translucent indicator (118) of a finger or a cross on the menu to indicate the position of the touch at the touch-sensitive region.

12. The computer-implemented method of claim 8, wherein the menu is configured to locate at or near an input cursor (106) or a mouse cursor (108).

13. The computer-implemented method of claim 8, further comprising:
receiving an indication of initialization; and
in response to receiving the indication of initialization, causing the display to display the menu.

14. The computer-implemented method of claim 11, further comprising:
receiving an indication of a first hand; and
in response to receiving the indication of the first hand, causing the display to display a first translucent indicator of a first finger of the first hand on the menu.

15. The computer-implemented method of claim 14, further comprising:
receiving an indication of a second hand; and
in response to receiving the indication of the second hand, causing the display to display a second translucent indicator of a second finger of the second hand on the menu.

16. The computer-implemented method of claim 11, further comprising:
receiving an indication of a shape of the touch; and
in response to receiving the indication of the shape of the touch, causing the display to present the translucent indicator of the finger based on the indication of the shape of the touch.

17. An electronic device (300), comprising:
a touch-sensitive screen (301) configured to display a virtual keyboard (305) including a touch-sensitive region (307), the touch-sensitive screen (301) configured to:
in response to detecting a touch on or above the touch-sensitive region (307) of the touch-sensitive screen (301), determine the position of the touch; and
send an indication of the position of the touch to a processor of the electronic device (300) to cause the electronic device (300) to select a menu item (309) of a menu (308) based on the position of the touch, the menu presented on the touch-sensitive screen (301) of the electronic device (300);
wherein a shape of the menu (308) matches a shape of the touch-sensitive region (307).

18. The electronic device (300) of claim 17, wherein the touch-sensitive region comprises a plurality of touch-sensitive keys including a menu key (32) arranged between a left space key (34) and a right space key (36) of the touch-sensitive keys.

19. The electronic device (300) of claim 17, wherein the touch-sensitive screen (301) is further configured to in response to detecting a press or a predetermined gesture on or above the touch-sensitive region, send an indication of initialization to the processor of the electronic device to cause the touch-sensitive screen (301) to display the menu.

20. The electronic device (300) of claim 17, wherein the touch-sensitive screen (301) is further configured to determine a shape of the touch, and send an indication of the shape to the processor of the electronic device.
